(19) United States
(12) Patent Application Publication
(10) Pub. No.: US 2021/0076459 A1
(43) Pub. Date: Mar. 11, 2021

(54) ELECTRICAL RESISTANCE HEATING ELEMENT

(71) Applicant: Redstone Commercial Investments LLC, Spring Lake, MI (US)

(72) Inventor: Ross E. Pope, Spring Lake, MI (US)

(21) Appl. No.: 17/014,137

(22) Filed: Sep. 8, 2020

Related U.S. Application Data
(60) Provisional application No. 62/897,034, filed on Sep. 6, 2019.

(51) Int. Cl. H05B 3/34; E01C 11/26

(52) U.S. Cl. CPC H05B 3/34; E01C 11/265; H05B 2203/014; H05B 2203/007; H05B 2203/011

(57) ABSTRACT

An electrical resistance heating element includes a non-rigid open mesh forming a grid. The mesh has opposed peripheral edges, each having an electrical conductor extending along a portion of the length thereof. One of the electrical conductors is configured to receive a positive electrical charge, and the other one of the electrical conductors is configured to receive a negative electrical charge. The mesh and the electrical conductors are coated with a conductive material, and the conductive material electrically connects the electrical conductors with one another. Further, the conductive material is electrically insulated with a dielectric material.

### CROSS REFERENCE TO RELATED APPLICATION

This application claims the benefit of U.S. Provisional Application 62/897,034, which was filed on September 6, 2019, the disclosure of which is hereby incorporated by reference.

### BACKGROUND OF THE INVENTION

### 1. Field of the Invention

The present invention pertains to a heating element for melting snow and ice. More particularly, the present invention pertains to an electrical heating element adapted to be buried under, or imbedded within, a surface such as a sidewalk for melting ice and snow deposited on the surface.

### 2. Description of the Prior Art

In areas of snowfall, accumulated snow and ice can create slippery surfaces, for example, walkways, sideways, driveways, etc , making it difficult or dangerous to walk on the surfaces. Various devices have been utilized for melting snow and ice. One such mechanism includes a plurality of tubes buried under a surface, and a heated liquid or an antifreeze liquid flows through the tubes to heat the surface. However, this heating approach leaves cool spots on the surface, and therefore is inefficient. In addition, installing this type of heating system often requires an entire new surface to be installed. Therefore, heating systems of this type are not suitable for installation after the surface has already been formed (such as concrete having been previously poured for a sidewalk).

### SUMMARY OF THE INVENTION

According to an aspect of the disclosure, an electrical resistance heating element is disclosed. The electrical resistance heating element includes a non-rigid flexible mesh, the mesh having a first peripheral edge member and a second peripheral edge member. The first peripheral edge member and the second peripheral edge member each have an electrical conductor extending along a portion of the length thereof, and one of the electrical conductors is configured to receive a positive electrical charge, and the other electrical conductor is configured to receive a negative electrical charge, whereby the mesh and the electrical conductors are electrically conductive.

Optionally, the mesh comprises a plurality of elongated members extending between the first peripheral edge member and the second peripheral edge member.

Optionally, the mesh includes a plurality of openings between the elongated members.

Optionally, the openings are substantially ¼ inch across or smaller

Optionally, the openings may be uniformly shaped with one another, or irregularly shaped with one another.

Optionally, the openings are substantially rectangular in shape.

Optionally, the electrical resistance heating element is electrically insulated.

Optionally, the elongated members comprise a core, a coating of electrically conductive material surrounding the core, and a dielectric material surrounding the coating of electrically conductive material.

Optionally, the core comprises glass fibers.

Optionally, the first peripheral edge member and the second peripheral edge member each comprise a plurality of conductive wires.

Optionally, the plurality of conductive wires are interwoven with the mesh.

Optionally, the plurality of conductive wires comprise metal.

Optionally, the electrical resistance heating element includes electrically conductive lead lines electrically connected to each of the electrical conductors, whereby providing an electrical charge to the lead lines will permit electricity to flow through the electrical conductors and the mesh.

Optionally, the electrical resistance heating element includes a third electrical conductor extending across the mesh, and the third electrical conductor is positioned between the first peripheral edge member and the second peripheral edge member.

Optionally, the third electrical conductor comprises a plurality of conductive wires which are optionally interwoven with the mesh and optionally comprise metal.

Optionally, the electrical resistance heating element includes an electrically conductive lead line electrically connected to the third electrical conductor.

For a more complete understanding of the present invention, reference is made to the following detailed description and accompanying drawings. In the drawings, like reference characters refer to like parts throughout the views in which:

### BRIEF DESCRIPTION OF THE DRAWINGS

FIG. 1 illustrates a mesh of a heating element disposed under a surface, in accordance with an embodiment of the disclosure;

FIG. 2 illustrates an enlarged view of a first peripheral edge member of the mesh depicting a first electrical conductor having electrical conducting wires interwoven with strands of a fabric, in accordance with an embodiment of the disclosure;

FIG. 3 illustrates an enlarged view of a second peripheral edge member of the mesh depicting a second electrical conductor having electrical conducting wires interwoven with strands of a fabric, in accordance with an embodiment of the disclosure;

FIG. 4 illustrates various layers of a first elongated member of the mesh, in accordance with an embodiment of the disclosure;

FIG. 5 illustrates various layers of a second elongated member of the mesh, in accordance with an embodiment of the disclosure; and

FIG. 6 illustrates a mesh, in accordance with an alternative embodiment of the disclosure.

### DETAILED DESCRIPTION OF A PREFERRED EMBODIMENT

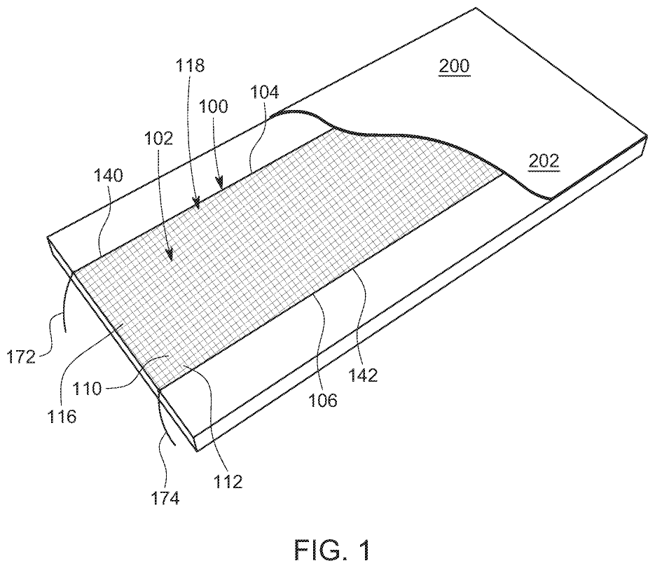

As shown in FIG. 1, an exemplary electrical resistance heating element 100 (hereinafter referred to as a heating element 100) adapted for melting ice and snow accumulated over a surface 200 is shown. In an implementation, the heating element 100 may be disposed within or buried underneath the surface 200 (e.g., a concrete surface 202) to melt the snow and/or ice. The heating element 100 includes a mesh 102 having a first peripheral edge member 104, and a second peripheral edge member 106. The second peripheral edge member 106 is disposed substantially parallel to the first peripheral edge member 104 and is positioned spaced apart from the first peripheral edge member 104.

The mesh 102 includes a plurality of first elongated members 110 extending generally between the first peripheral edge member 104 and the second peripheral edge member 106. Preferably, the plurality of first elongated members 110 extends substantially perpendicular to both the first peripheral edge member 104 (hereinafter referred to as first edge member 104) and the second peripheral edge member 106 (hereinafter referred to as second edge member 106), such that the first elongated members 110 connect the first edge member 104 to the second edge member 106. As shown, the first elongated members 110 are disposed spaced apart from each other, thereby defining a gap therebetween. Also, the mesh 102 preferably includes a plurality of second elongated members 112 which extend across the first elongated members 110, but do not necessarily connect directly to the first edge member 104 and/or the second edge member 106. Preferably, the second elongated members 112 extend substantially parallel to the first edge member 104 and the second edge member 106, and are disposed between the first edge member 104 and the second edge member 106. As illustrated, the plurality of second elongated members 112 intersect or connect the plurality of the first elongated members 110 to define a plurality of openings 116 therebetween. The openings 116 can be any suitable size or shape as desired, but preferably the openings are about ¼ inch wide by ¼ inch tall. Therefore, the mesh 102 includes a grid 118 having the plurality of openings 116 separated by first elongated member 110 and/or the second elongated member 112 from each other.

When the surface 200 is water permeable, then the openings 116 facilitate a passage of liquid, such as water, through the mesh 102. In an embodiment, the mesh 102 may include a rectangular structure. Although a rectangular structure is contemplated and shown in the drawings, it may be envisioned that the mesh 102 can have any polygonal structure, such as a triangular structure, a pentagonal structure, a diamond structure, etc. Although the mesh 102 shown in the drawings has rectangular openings, it is appreciated that the first elongated members 110 and/or the second elongated members 112 can each be oriented randomly or at various angles with respect to the first edge member 104 and the second edge member 106.

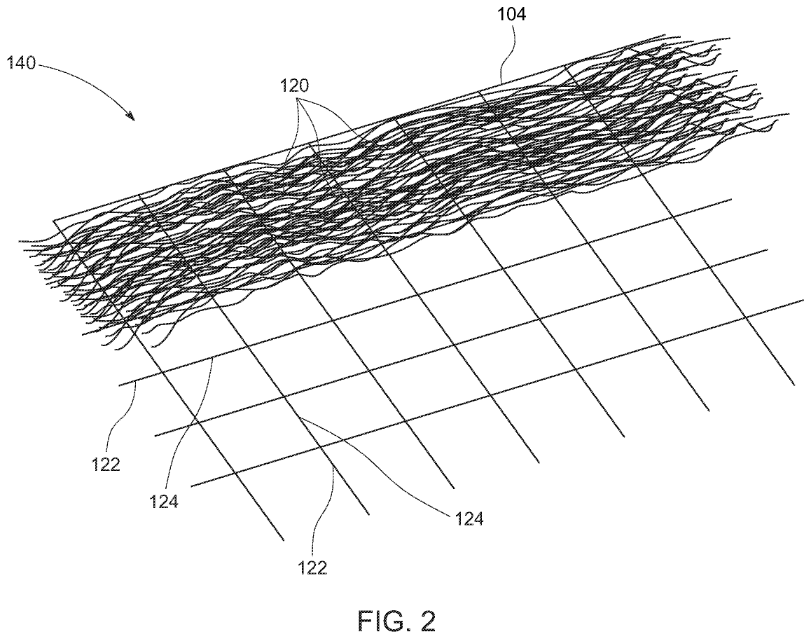

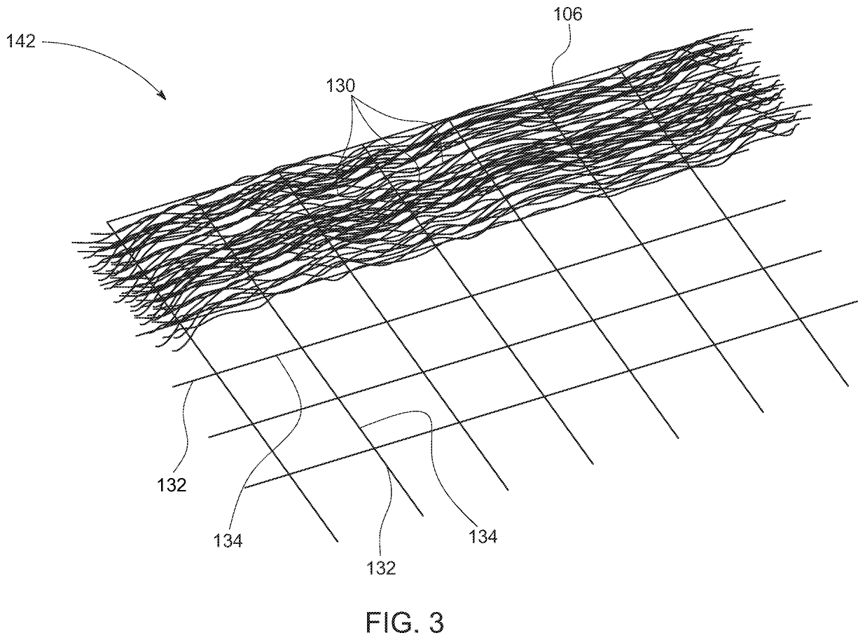

Referring to FIG. 2, the first peripheral edge member 104 may include one or more electrically conducting wires 120 extending, at least partly, along a length of the first edge member 104. The electrically conducting wires 120 may be formed from any suitable conductive material, such as copper wires. In an embodiment, the electrically conducting wires 120 may be interwoven with one or more strands 122 of a fabric 124 in the mesh 102. For example, the strands of the fabric 124 can include glass-fibers. Similar to the first edge member 104, and as shown in FIG. 3, the second peripheral edge member 106 may include one or more electrically conducting wires 130 for facilitating a passage of electricity through the second edge member 106. The conducting wires 130 may extend, at least partly, along a length, of the second edge member 106. The electrically conducting wires 130 are also formed from any suitable conductive material, such as copper wire. In an embodiment, the electrically conducting wires 130 may be interwoven with one or more strands 132 of a fabric 134 in the mesh 102. Each strand 132 of the fabric 134 may include glass-fibers.

Due to the electrically conducting wires 120, 130, the first edge member 104 and the second edge member 106 are adapted to provide a flow of electricity through the mesh 102. In this manner, the first edge member 104 defines a first electrical conductor 140, or bus, of the mesh 102, while the second edge member defines a second electrical conductor 142, or bus, of the mesh 102. In an embodiment, the first electrical conductor 140 and the second electrical conductor 142 each may also include a coating of electrically conductive material (not shown). Furthermore, the first electrical conductor 140 and the second electrical conductor 142 are preferably electrically insulated, such as by being covered or coated with a dielectric material.

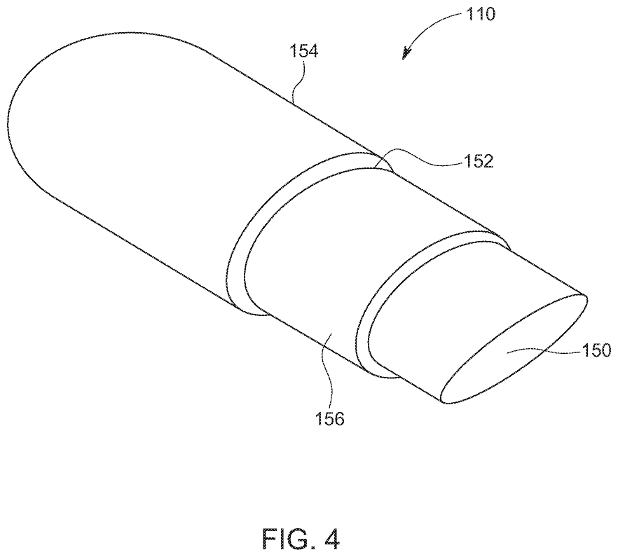

Furthermore, as shown in FIG. 4, each first elongated member 110 of the mesh 102 may include: (1) a core 150 (hereinafter referred to as a first core 150); (2) a first layer 152 disposed over the first core 150 and encapsulating the first core 150; and (3) a second layer 154 encapsulating the first layer 152 and the first core 150. In this manner, the first layer 152 is sandwiched between the first core 150 and the second layer 154. In certain implementations, the first core 150 may be made of a fabric and may include a plurality of flexible fibers interwoven together. Preferably the fibers are glass-fibers. Furthermore, the first layer 152 is preferably formed by applying a coating 156 of an electrically conductive material on the first core 150. In certain implementations, the coating 156 may be applied by applying a slurry of electrically conducting material on the first core 150. Preferably, the coating 156 may be graphite carbon. However, it may be envisioned that various other coatings 156 of electrically conductive materials known in the art may also be utilized. Furthermore, the coating 156 of electrically conductive material has an electrical resistance within a certain threshold range to generate heat when an electric current flows through the first elongated members 110. In addition, the second layer 154 is a dielectric material which is preferably deposited over the first layer 152 to provide electrical insulation.

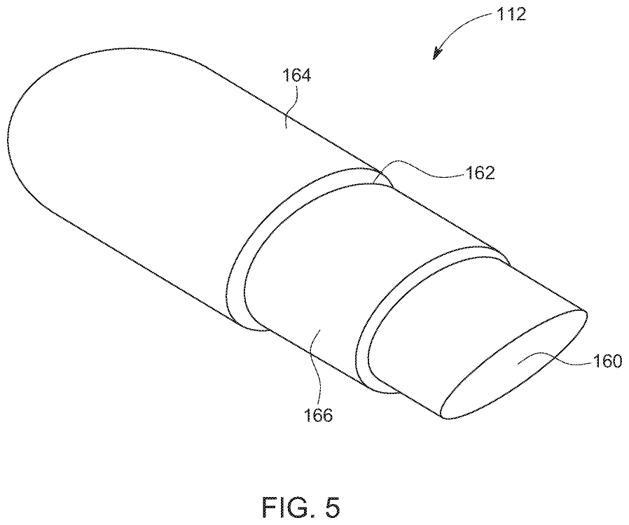

Similar to the first elongated member 110, and as illustrated in FIG. 5, each second elongated member 112 may include: (1) a core 160 (hereinafter referred to as a second core 160); (2) a third layer 162 disposed over the second core 160 and encapsulating the second core 160; and (3) a fourth layer 164 encapsulating the third layer 162. In this manner, the third layer 162 is sandwiched between the second core 160 and the fourth layer 164. In certain implementations, the second core 160 is made of a fabric and may include a plurality of fibers interwoven together. Preferably the fibers are glass-fibers. Furthermore, the third layer 162 is formed by applying a coating 166 of an electrically conductive material on the second core 160. Preferably, the coating 166 is applied by applying a slurry of electrically conductive material on the second core 160. Preferably, the coating 166 may be graphite carbon. However, it may be envisioned that various other coatings 166 of electrically conductive materials known in the art may also be utilized. Furthermore, the coating 166 of electrically conductive material has an electrical resistance within a certain threshold range to generate heat when electric current flows through the second elongated members 112. The fourth layer 162 is a dielectric material which is preferably deposited over the third layer 162 to provide electrical insulation.

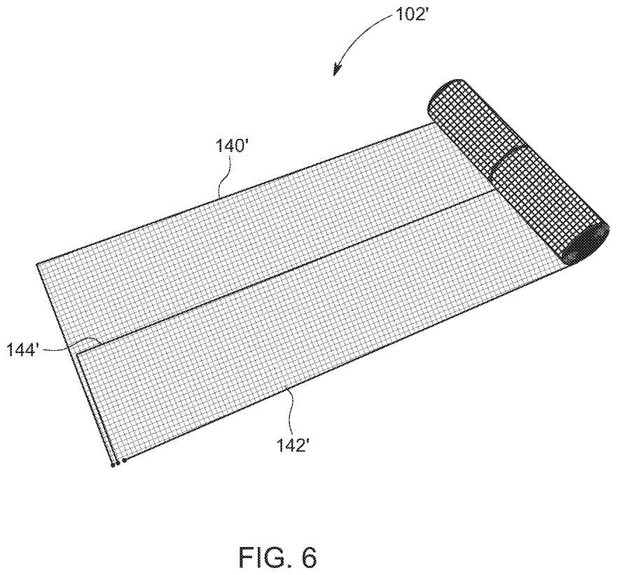

Referring now to FIG. 6, a mesh 102′ according to an alternative embodiment of the disclosure is shown. The mesh 102′ is similar in structure, construction, and function to that of the mesh 102 except that the mesh 102′ includes a third electrical conductor 144′, or bus, disposed between a first electrical conductor 140′ and a second electrical conductor 142′. The third electrical conductor 144′ may be disposed substantially parallel to the first electrical conductor 140′ and the second electrical conductor 142′. The construction and structure of the third electrical conductor 144′ is the same as that of the first electrical conductor 140′ and/or the second electrical conductor 142′. Furthermore, the third electrical conductor 144′ may function as a neutral terminal.

Although not shown in the drawings, the heating element 100 may include a power source (not shown) connected to the first electrical conductor 140 and the second electrical conductor 142 to provide a flow of electricity through the mesh 102. The power source can be a 110 Volt/30-amp circuit, a 220 Volt/30-amp circuit, or any other suitable circuit that is well-known in the art. Furthermore, the power source can be powered from the electrical grid, a stand-alone battery, or any other suitable type of power source. In an embodiment, the first electrical conductor 140 may be connected to a positive terminal of the power source to receive a positive charge, while the second electrical conductor 142 may be connected to a negative terminal of the power source to receive a negative charge. Referring back to FIG. 1, the heating element 100 preferably includes a pair of lead lines. For example, a first lead line 172 electrically connects the power source to the first electrical conductor 140, and a second lead line 174 electrically connects the power source to the second electrical conductor 142.

An operation of the heating element 100 is now explained. In order to melt snow and/or ice deposited on the surface 200, the user/operator provides electrical power to the lead lines 172 and 174, and an electric current starts flowing through the coatings of electrically conductive material on the mesh 102 via the first elongated members 110, the second elongated members 112, and the electrical conductors 140, 142. Due to the electrical resistance of the coatings 156, 166, on the first elongated members 110 and the second elongated members 112, heat is generated when electric current flows through the mesh 102. Therefore, the surface 200 is heated from the heat generated by the mesh 102, which in turn melts snow or ice accumulated on the surface 200. In this manner, the heating element 100 melts and removes ice and/or snow accumulated on the surface 200. Also, the mesh 102 in the heating element 100 provides a uniform heating over the surface 200 due to the relatively tight, or close structure of the mesh 102 to provide an even application of heat to the surface 200 without any cold spots.

Furthermore, the heating element 100 can be manufactured in any variety of sizes or shapes, although preferably the heating element 100 is rectangular in shape. Because the heating element 100 is formed from flexible materials, the heating element 100 can be rolled up for shipping or prior to installation. In addition, any excess length of the heating element 100 can be cut off during installation and the function of the heating element 100 will not be affected.

Although the heating element 100 can be installed when the surface 200 is being formed, the heating element 100 is also envisioned to have particular usefulness for installation on top of existing surfaces 200. For example, it is envisioned that the heating element 100 can be installed atop a sidewalk by placing the heating element 100 over the surface, making any electrical connections as needed, and then placing a thin layer of concrete or mortar above the heating element 100 to retain the heating element 100 in position. And since the entire heating element 100 is covered by a dielectric material, then the heating element 100 is electrically insulated from the surrounding environment for safety purposes and is also resistant to corrosion.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

What is claimed is:

1. An electrical resistance heating element comprising:
a non-rigid flexible mesh, the mesh having a first peripheral edge member and a second peripheral edge member, the first peripheral edge member and the second peripheral edge member each having an electrical conductor extending along a portion of the length thereof, one of the electrical conductors being configured to receive a positive electrical charge, and the other one of the electrical conductors being configured to receive a negative electrical charge; and
whereby the mesh and the electrical conductors are electrically conductive.

2. The electrical resistance heating element of claim 1 wherein the mesh comprises a plurality of elongated members extending between the first peripheral edge member and the second peripheral edge member.

3. The electrical resistance heating element of claim 1 wherein the mesh includes a plurality of openings between the elongated members.

4. The electrical resistance heating element of claim 3 wherein the openings are substantially ¼ inch across or smaller

5. The electrical resistance heating element of claim 3 wherein the openings are uniformly shaped with one another.

6. The electrical resistance heating element of claim 3 wherein the openings are irregularly shaped with one another.

7. The electrical resistance heating element of claim 5 wherein the openings are substantially rectangular in shape.

8. The electrical resistance heating element of claim 1 wherein the electrical resistance heating element is electrically insulated.

9. The electrical resistance heating element of claim 2 wherein the elongated members comprise a core, a coating of electrically conductive material surrounding the core, and a dielectric material surrounding the coating of electrically conductive material.

10. The electrical resistance heating element of claim 9 wherein the core comprises glass fibers.

11. The electrical resistance heating element of claim 1 wherein the first peripheral edge member and the second peripheral edge member each comprise a plurality of conductive wires.

12. The electrical resistance heating element of claim 11 wherein the plurality of conductive wires are interwoven with the mesh.

13. The electrical resistance heating element of claim 11 wherein the plurality of conductive wires comprise metal.

14. The electrical resistance heating element of claim 1 including electrically conductive lead lines electrically connected to each of the electrical conductors, whereby providing an electrical charge to the lead lines will permit electricity to flow through the electrical conductors and the mesh.

15. The electrical resistance heating element of claim 1 including a third electrical conductor extending across the mesh, the third electrical conductor being positioned between the first peripheral edge member and the second peripheral edge member.

16. The electrical resistance heating element of claim 15 wherein the third electrical conductor comprises a plurality of conductive wires.

17. The electrical resistance heating element of claim 16 wherein the plurality of conductive wires are interwoven with the mesh.

18. The electrical resistance heating element of claim 17 wherein the plurality of conductive wires comprise metal.

19. The electrical resistance heating element of claim 15 including an electrically conductive lead line electrically connected to the third electrical conductor.
